(19) United States
(12) Patent Application Publication
(10) Pub. No.: US 2023/0398538 A1
(43) Pub. Date: Dec. 14, 2023

(54) DEVICE WITH A DISPENSER FOR DISPENSING A LIQUID SAMPLE

(71) Applicant: CYTENA GmbH, Freiburg (DE)

(72) Inventor: Jonas FÖLLING, Freiburg (DE)

(21) Appl. No.: 18/199,744

(22) Filed: May 19, 2023

(30) Foreign Application Priority Data
May 21, 2022 (LU) LU502135

(51) Int. Cl. B01L 3/00

(52) U.S. Cl. CPC B01L 3/502761; B01L 2300/0654; B01L 2300/168; B01L 2300/0681; B01L 2200/0652

(57) ABSTRACT

The invention relates to a device having a dispenser for receiving liquid sample which has liquid and particles, a first light source of a first type for emitting a first illumination light for illuminating a first region of the dispenser, a first detection device for detecting a first optical measurement signal that emanates from the first region of the dispenser illuminated with the first illuminating light, a second light source of a second type for emitting a second illuminating light for illuminating a second region of the dispenser which comprises the first region of the dispenser, and a second detection device for detecting a second optical measurement signal which emanates from the second region of the dispenser illuminated with the second illuminating light. The device is characterized in that the first detection device is a point detector.

This application claims priority from Luxembourg Application No. LU502135, filed on 21 May 2022, the entirety of which is incorporated herein by reference.

The invention relates to a device having a dispenser for receiving a liquid sample that has liquid and particles. The invention also relates to the use of the device for examining a liquid sample.

It is known from the prior art that active ingredients such as monoclonal antibodies and other proteins are produced with the aid what are termed of monoclonal cell lines. These are populations of cells all descended from a single mother cell. The production of monoclonal cell lines is necessary because this is the only way to ensure that all cells in the population have an approximately same genome in order to produce the active ingredients with a constant and reproducible quality.

To generate a monoclonal cell line, cells are individually transferred to receptacles of a microtiter plate. The cells to be transferred are produced by genetically modifying a host cell line and individualizing these modified cells. Individual cells are deposited in the microtiter plates using devices that are also referred to as dispensing devices.

There is a need for the liquid to be dispensed to be examined to determine whether it contains particles, such as cells. In addition, it is often desired that when dispensing particles, they are assessed and, if necessary, sorted on the basis of their size and shape, but often also their fluorescent properties. An imaging reflected or transmitted light microscope is required to examine the size and shape. In the case of larger particles, this arrangement is also useful for a fluorescence signal if a spatial distribution of the fluorescence signal can be resolved. In the case of small particles contained in the liquid sample, however, it is not possible to resolve the fluorescence signal. Therefore, these particles can be overlooked during operation of the device and thus, for example, dispensed into the wrong receptacle.

The device operation is further complicated by the fact that an objective with a high numerical aperture is used in order to obtain a high resolution of the viewed region of the dispenser in a focal plane of the objective and a high detection signal of the fluorescence signal. However, this has the disadvantage that the depth of field of the observed region of the dispenser decreases. This means that the region perpendicular to the focal plane that is in focus becomes smaller. Particles lying outside the focal plane can only be recognized with little contrast or not at all. In other words, particles that are not arranged in the focal plane are often not detected in an objective with a high numerical aperture.

A device is known from EP 3 561 040 A1, in which a fluorescence signal is detected by means of a surface sensor. However, the previously mentioned problem arises with the known device that small particles often cannot be detected and the number of faulty dispensing processes is therefore high.

The object of the invention is therefore to specify a device in which the number of incorrect dispensing processes is reduced.

This object is achieved by a device having
a dispenser for receiving liquid sample, which has liquid and particles,
a first light source of a first type for emitting a first illumination light for illuminating a first region of the dispenser,
a first detection device for detecting a first optical measurement signal, which emanates from the first region of the dispenser illuminated with the first illumination light,
a second light source of a second type for emitting a second illumination light for illuminating a second region of the dispenser, which comprises the first region of the dispenser, and
a second detection device for detecting a second optical measurement signal, which emanates from the second region of the dispenser illuminated with the second illuminating light, characterized in that the first detection means is a point detector.

According to the invention, it was recognized that the number of incorrect dispensing processes can be reduced if a point detector is used to detect the first optical measurement signal. The number of incorrect dispensing processes is reduced because it was recognized that a spatial resolution of the first optical measurement signal is not necessary, but it is sufficient that the first optical measurement signal is only evaluated with regard to its intensity and/or whether a particle is even arranged in the first region or not. This makes it possible for particles such as microorganisms, which can be small and are not arranged in the focal plane of an objective, to be detected. This is because with a point detector, the entire signal across the entire detector region is measured at once. As soon as the overall signal is above the measuring threshold of the detector, it is detected. In contrast, with a spatially resolving detector, the two-dimensional signal is distributed over many small sub-units of the detector, which are all read out individually. Thus, for each individual sub-unit of the detector, the signal must be above its detection threshold in order to obtain a displayable signal. A much larger optical measurement signal is therefore necessary in order to provide each individual subunit with a significant signal, so that a spatial signal can be represented.

Another advantage is that the point sensor is low-noise and therefore a signal-to-noise ratio from a point sensor is better than when using a region sensor. Thus, the point detector is also superior to a spatially resolving detector, even if the signal of all subunits is summed in the latter. As explained in detail below, when using a point detector, the signal detection is not limited to the particle resting in the first region, but the detection of the first optical measurement signal can take place during a pumping process in which, after a dispensing process, liquid sample is poured into the first region reached.

A point detector is understood to be a detector in which there is no spatial resolution of the first region. The point detector can comprise a pixel and/or is designed in such a way that it receives the entire first optical measurement signal. The point detector can have several detector sub-units. The point detector is designed in such a way that spatial resolution of the signal is not possible, i.e., it cannot be determined from which detector subunits the signal originates. The point detector can be a photomultiplier (PMT) or a silicon photomultiplier (SiPM). In addition, the point detector can also be a section of a region detector. This offers the advantage that an already existing region detector of the device can be used as a point detector and therefore no additional detector is required. The region of the region detector used as a point detector can be selected. Thus, depending on the structural deviation of the region detector, it can be decided which region of the region detector is to be read out and thus functions as a point detector.

The particles can be biological particles, where the biological particles can be microorganisms such as bacteria, archaea, yeast, fungi, and viruses, or cells, DNA, RNA, or proteins. The liquid sample can contain one or more of the aforementioned biological particles. The liquid can be a suspension that can promote a growth of the biological particles arranged in the liquid. Alternatively, the particle may be a glass or polymer bead, particularly having the same or substantially the same volume as a cell. The liquid of the liquid sample can be the same liquid that is arranged in a receptacle into which the liquid sample is dispensed.

The liquid sample distributed by means of the device, in particular by the dispenser, can be a drop, in particular a free-flying drop. The liquid droplet may have a volume in a range between 1 fL (femtoliter) and 1 μL (microliter), in particular between 1 pL (picoliter) and 1 μL (microliter). The sample output can be carried out according to a drop-on-demand operating mode. In this case, the device dispenses samples discretely and not continuously. In order to implement the drop-on-demand mode of operation, the device can have an actuating means. Alternatively, the liquid sample that is dispensed can be a jet which, after being dispensed from a dispenser, may break up into individual liquid droplets.

A dispenser is understood to mean a device that receives a liquid sample. In addition, the dispenser dispenses liquid sample after actuation by the actuation means. The dispenser can be used in a detachable manner in a holder of the device. This makes it possible to exchange the dispenser, for example to avoid contamination of liquid samples. The dispenser can have a section, in particular a mechanical membrane, which is actuated by the actuating means in order to dispense liquid sample.

The liquid sample dispensed from the device may comprise liquid and not a particle. Alternatively, the liquid sample dispensed may have liquid and a single particle. In addition, the liquid sample dispensed may have liquid and more than a single particle.

A first light source of a first type differs in light source type from a second light source of a second type. What both light sources have in common is that they illuminate a region of the dispenser and that a measurement signal then emanates from the respective region. The first measurement signal and the second measurement signal can differ from one another in that an evaluation of the first measurement signal and of the second measurement signal each takes a different amount of time.

In a particular embodiment, the first region may comprise a dispensing outlet. The liquid sample can be dispensed from the dispenser through the dispensing outlet. The first region can comprise a dispensing region from which a liquid sample is dispensed during a dispensing process. The first region can also comprise a certainty region for the dispenser in which it cannot be determined with certainty whether the liquid sample arranged in the certainty region will be ejected during a dispensing process. The first region thus does not comprise a dispenser region that contains liquid sample that will certainly not be ejected during a dispensing process. It is thus ensured that the first detection device only detects particles arranged within the first region. Particles arranged outside of the first region are therefore not detected by the first detection device.

In an alternative embodiment, the first illumination light can also illuminate a first region that contains liquid sample that is not ejected during the next dispensing process. However, it must then be ensured that the signal from particles that are in a region in which the liquid is not ejected during the next dispensing process does not fall on the first detection device. This can be achieved by a suitable size of the first detection device, a suitable optical imaging or screens for screening out the unwanted first measurement signal. What is relevant is that no signal from particles that are not ejected during the next dispensing process reaches the first detection device.

The second region can completely comprise the first region. The second region can be larger than the first region. Since the second region can comprise the first region, the second region can comprise the dispensing outlet. In addition, analogously to the first region, the second region can comprise the dispensing region from which the liquid sample is dispensed during the next dispensing process. In addition, the second region can comprise a larger region than the dispensing region from which the liquid sample is dispensed in the next but one dispensing process. As a result, the second optical measurement signal can also be evaluated in advance for a region that is not part of the dispensing region. This reduces the computing time when, after a dispensing process, the liquid sample located outside of the dispensing region reaches the dispensing region.

The device can be designed in such a way that the first region and/or the second measurement region are/is not scanned point by point by the first illumination light and/or the second illumination light in order to obtain an image of the respective region. In other words, the first illumination light is not shifted so that it illuminates different regions of the dispenser. Likewise, the second illumination light is not shifted in such a way that it illuminates different regions of the dispenser.

The objective can be arranged in such a way that an optical axis of the objective runs transversely or perpendicularly to an ejection direction of liquid sample from the dispenser. Such an arrangement of the objective offers the advantage that the objective can be arranged closer to the dispenser than in known devices in which the objective is arranged above the dispenser. As a result, the previously described arrangement of the objective increases the resolution and/or the magnification is by. It is advantageous if the objective has a numerical aperture of 0.1 to 1.5, in particular 0.1 to 0.5. As a result, a high resolution of the first and/or second region can be achieved. As is described in more detail below, a high numerical aperture is particularly advantageous when evaluating the first optical measurement signal.

The device can be designed in such a way that the first region is not imaged directly onto the first detection device, i.e., the detection device is not located in an image plane of the first region. If the first region is imaged directly, the form and the position of the first optical measurement signal on the first detection device can differ depending on the position of the particle within the first region. This is because an image of the first region is generated on the first detection device when the first region is optically imaged on the first detection device. Correspondingly, the first measurement signal of a particle is imaged at the point of the first detection device which corresponds to the position of the particle in the image. The first measurement signals, which contain information on particles that are in different focal positions, are imaged with different sharpness, so the imaged particle appears to be of a different size. A point detector cannot spatially resolve these differences. For some first detection devices, such as PMTs, it is also irrelevant for the measured first measurement signal where and at what size the first measurement signal strikes the detector surface.

With other first detection devices, such as SiPMs for example, it is advantageous if the first measurement signal always hits the detector surface as homogeneously as possible, since otherwise the dynamics of the first detection device cannot be fully utilized. Individual regions of the first detection device can become “saturated” if there is too much local first measurement signal, so that they cannot detect the entire first measurement signal arriving at this point. This case of saturation can occur if the first measurement signal reaches a point of the first detection device in too concentrated a manner. In this case, the first detection device would detect less first measurement signal than was actually received. If the same first measurement signal had been distributed over the entire detector surface, the local intensity of the first measurement signal would have been lower and the first detection device would not have been saturated at any point. Thus, the correct signal strength could have been registered.

It is therefore advantageous to prepare the first measurement signal optically in such a way that it impinges on the first detection device as homogeneously as possible, regardless of the position of the particle in the first region.

This can be realized, for example, by the following two options, which can also be combined with each other:

According to one embodiment, the device can have a light guide. The first region is imaged onto a light guide, in particular an input of the light guide, and/or can be arranged in the beam path of the first optical measurement signal. The light guide can be arranged in such a way that the first optical measurement signal emerging from the light guide can be fed to the first detection device. In addition, the light guide can be designed in such a way that the first optical measurement signal exiting the light guide has a more uniform intensity distribution profile than the first optical measurement signal entering the light guide.

The light guide can be an optical fiber, in particular a glass fiber, in particular a multimode glass fiber, or a liquid-filled light guide, in particular a liquid light guide. The imaging can take place in such a way that the entire first measurement signal lies within the numerical aperture of the light guide. The entire or almost the entire first measurement signal is thus coupled into the light guide. It is irrelevant where the exact position of the signal-emitting particle is in the first region, as long as the optical imaging is chosen appropriately. By laying the light guide in suitable curves or waves, the light is redistributed within the light guide and fills all modes of the light guide, the process is known as “mode scrambling”. The first measurement signal, which leaves the light guide, is thus well-defined and the spatial light distribution of the first measurement signal is independent of the distribution of the first measurement signal entering the light guide. This well-defined light distribution can either be directed to the first detection device or imaged using additional optics.

According to a further embodiment, the device can have a lens which is arranged in the beam path of the first optical measurement signal. In this embodiment, the first detection device, in particular the point sensor, is not placed directly in the image plane of the first image of the first region, rather the lens is placed in such a way that the image plane is in the back focal plane of the lens. The lens is placed in the optical system of the device in such a way that the first optical measurement signal is collimated, in particular as well as possible. In this case, the first detection device is placed behind the further lens, so that the first detection device receives the first optical measurement signal collimated by the lens. It is advantageous to place the first detection device at a distance equal to the focal length of the lens, i.e., the pupil plane. Thus, the first measurement signal, which emanates from a single particle, is distributed almost homogeneously over a larger region.

The size of the surface can be optimized via the optical system, in particular the focal lengths of the lenses used and their distances, so that it optimally fills the detector surface. Different positions of different particles in the first region only bring about a change in the angle of the first measurement signal at the point of the first detection device, which does not have a major impact on most of the first detection devices to the extent expected. Thus, the first measurement signal is always directed to the first detection device over a large region, regardless of the position of the particle.

The device can have an actuating means for actuating the dispenser to dispense liquid sample. The actuating means can be a piezoelectric actuator, which can have a piston, and/or can actuate the section of the dispenser, in particular the mechanical membrane. When the section of the dispenser is actuated by the actuating means, the liquid sample, in particular a drop, is ejected from the dispenser. The actuating means and the objective can face each other with respect to the dispenser.

In a particular embodiment, the first illumination light and/or the second illumination light and/or the first measurement signal and/or the second measurement signal can depend on the optical measurement method. Thus, the first illumination light can be an excitation light for fluorescence and/or the first measurement signal can be a fluorescence signal. The second illumination light can be bright field light and/or the second measurement signal can be a bright field signal. As an alternative or in addition to a bright field method and/or fluorescence method, the optical measurement method can comprise a phase contrast method, a dark field method or a Raman spectroscopy method. The fluorescence method can also include a measurement of fluorescence lifetime.

In a particular embodiment, the device can have a filter element for filtering part of the second measurement signal. The filter element can have a first filter region through which the first and second measurement signals penetrate. The first filter region can be an opening, so that the first and second measurement signals can pass through the filter element unhindered. In addition, the filter element can have a second filter region. The second filter region can be designed in such a way that the first measurement signal passes through the second filter region. In contrast, the second measurement signal cannot pass through the second filter region and/or is filtered by the second filter region. The second filter region can enclose the first filter region, in particular completely. The first and second filter regions can be arranged to be coaxial with one another.

The filter element has the effect that an image of the first and/or second region can be obtained which has a sufficient depth of focus. This is possible because the second measurement signal is filtered in the second filter region and only the unfiltered second measurement signal is detected by the second detection device. In addition, the filter element enables a first optical measurement signal to be detected, which can be used to assess whether a particle is arranged in the first region of the dispenser. This is possible because the second filter region does not filter the first measurement signal but allows it through, so that a first optical measurement signal intensity is sufficiently high to be able to evaluate it. Since a point sensor is used, it is irrelevant that the first optical measurement signal is out of focus when the particle is not arranged in the focal plane.

The filter element can be arranged in the beam path of the first and/or second measurement signal after the objective and before the point detector and/or the second detection device. In this respect, the filter element can be integrated into the device without great effort.

The first illumination light and the first measurement signal can at least partially have a common beam path. In addition, the second illumination light and the second measurement signal can at least partially have a common beam path. In addition, the first illumination light and the second illumination light can at least partially have a common beam path and/or the first measurement signal and the second measurement signal can at least partially have a common beam path. As a result, a simply constructed device can be implemented which has few components.

In a particular embodiment, the device can have at least one imaging device for generating an image. The imaging device can generate at least one image on the basis of the first measurement signal and/or the second measurement signal.

In addition, the device can have at least one evaluation device for evaluating the first measurement signal and/or the second measurement signal. The evaluation device can be part of the imaging device. In addition, the evaluation device can have at least one processor or be a processor. The evaluation device can have or be a printed circuit board.

Based on the first measurement signal, the evaluation device can determine whether a particle is arranged in the first region. In particular, the evaluation device can determine that a particle, in particular a fluorescent particle, is arranged in the first region when the detected first measurement signal satisfies a predetermined condition. The specified condition can be that a signal intensity of the first measurement signal is greater than a specified signal intensity. Alternatively or additionally, the predefined condition can be that a signal value integrated over time is greater than a predefined value. As a result, the evaluation device can be used to determine in a simple and precise manner whether a particle, in particular a fluorescent particle, is arranged in the first region.

Based on the second measurement signal, the evaluation device can determine whether a predetermined number of particles is arranged in the second region. The predetermined number can have the value 0, so that no particles are arranged in the second region. Alternatively, the predetermined number can have a value greater than 0, in particular exactly 1. The predetermined number can be set by the user or automatically, in particular before the dispensing process is carried out.

The evaluation of the two measurement signals can be combined with one another. In a first step, the second measurement signal can be evaluated to determine whether a predetermined number of particles is arranged in the second region. In a second step, the first measurement signal can then be evaluated to determine whether at least one particle that was determined using the first measurement signal fluoresces or not.

A simple way of determining whether at least one particle, in particular exactly a single particle, is arranged in the second region can consist in determining an optical property of the second region based on the detected second measurement signal. For example, by determining the contrast in the second region of the dispenser, it can be determined whether a particle is arranged in the second region. Alternatively or additionally, other optical properties of the second region can also be determined in order to determine whether at least one particle, in particular exactly a single particle, is arranged in the second region.

In addition, the evaluation device can determine a physical particle property based on the second measurement signal. A “physical property” is understood to mean a quantity that can be measured and/or observed by experiment. In this way, the morphology and/or granularity and/or position and/or size and/or color of the particle can be determined as a particle property.

In one implementation, the device may include a controller. The control device can have at least one processor or be a processor. The control device can have or be a printed circuit board. The control device can be electrically connected to the evaluation device.

The control device can cause the first light source to be switched on before the second light source. Thus, the first region can be illuminated in time before the second region. The first light source can be switched on before the particle is stationary in the first region. This is possible because the point detector only detects the presence of the particle and the blur resulting from the particle movement is irrelevant for the point detector. The control device can cause the first light source to be switched on during the dispensing process. This means that the first light source is also switched on after the dispenser has been actuated by the actuating means. Upon actuation of the dispenser, the particle moves toward the dispenser outlet and is ejected through the dispenser outlet. As discussed above, the blur resulting from particle motion is irrelevant to the point detector. It is advantageous that a long exposure time is obtained, as a result of which small particles can be detected by the point detector.

A dispensing process is understood to mean a process in which the actuating means actuates the dispenser at an actuation time. As a result of the actuation, liquid sample is dispensed from the first region of the dispenser. Liquid sample that is arranged in the dispenser outside of the first region then flows into the first region.

The control device can cause an exposure time by the first illumination light to be longer than an exposure time by the second illumination light. The shorter exposure time by the second illumination light results from the second detection device spatially resolving the second region. Particle motion is undesirable to obtain good spatial resolution, so illumination is delayed until the particle is stationary. The time of exposure by the second illumination light can depend on the time of actuation by the actuation means. The second region can thus be illuminated at a point in time which is a first predetermined time period after the actuation point in time by the actuating means. The exposure of the second region may be terminated at another point in time which is a second predetermined period of time after the point in time.

The control device can determine a storage location depending on an evaluation result. In particular, the control device can cause the dispenser to dispense liquid sample into the specific storage location. The storage location can be a receptacle. A carrier can have the receptacle. The carrier can have a large number of receptacles. The carrier can be a microtiter plate.

The device can also have a moving device for moving the dispenser and/or the carrier. The control device can control the moving device in such a way that the moving device moves the dispenser and/or the carrier into a position in which the liquid sample to be dispensed from the dispenser can be dispensed into the desired receptacle of the carrier. The device can automatically determine the storage location of the liquid sample to be dispensed.

The control device can control the moving device based on the evaluation result. In particular, the control device can determine a storage location, in particular the receptacle, depending on the evaluation result. The control device can thus determine the storage location depending on the presence of a particle in the first region and/or on the number of particles in the second region. As an alternative or in addition, the control device can determine the storage location as a function of the particle property.

The device can have a deflection and/or suction device. The deflection device serves to deflect the dispensed liquid sample, in particular the dispensed drop. The suction device is used to suction off the dispensed liquid sample. The dispensed liquid can be diverted and/or suctioned into a waste receptacle. The deflection and/or suction can take place before the liquid that is dispensed enters the receptacle, in particular the receptacle of a microtiter plate. The dispensed liquid can be deflected and/or suctioned off when the liquid does not contain any particles. Alternatively, the liquid that is dispensed can be deflected and/or suctioned off when the number of particles contained in the liquid is greater or less than a predetermined value, in particular greater than 1.

It is of particular advantage if the device according to the invention is used for examining liquid samples. It is particularly advantageous if the particles of the liquid sample to be examined have a diameter of 0.1 μm (micrometers) to 12 μm, in particular 0.1 μm (micrometers) to 5 μm. In particular, microorganisms can be examined using the device according to the invention.

The subject matter of the invention is shown schematically in the figures, wherein elements that are the same or have the same effect are usually provided with the same reference symbols. In the figures:

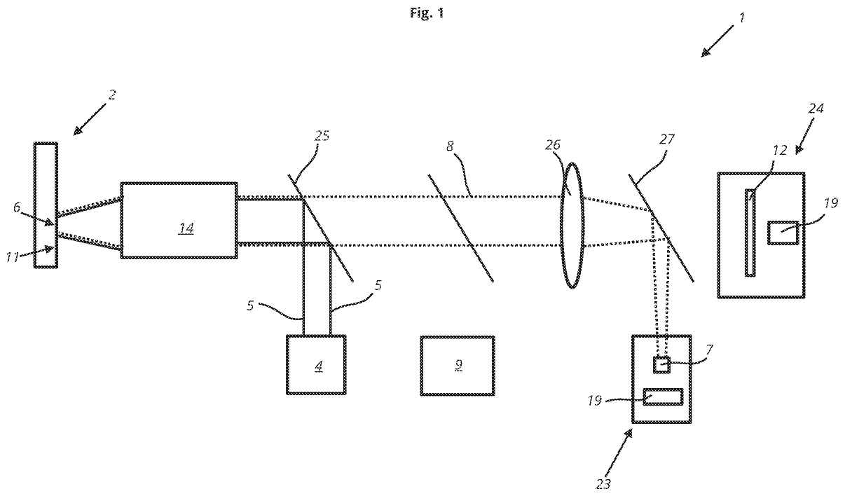

FIG. 1 shows part of the device according to a first embodiment of the invention, in which a first light source is switched on,

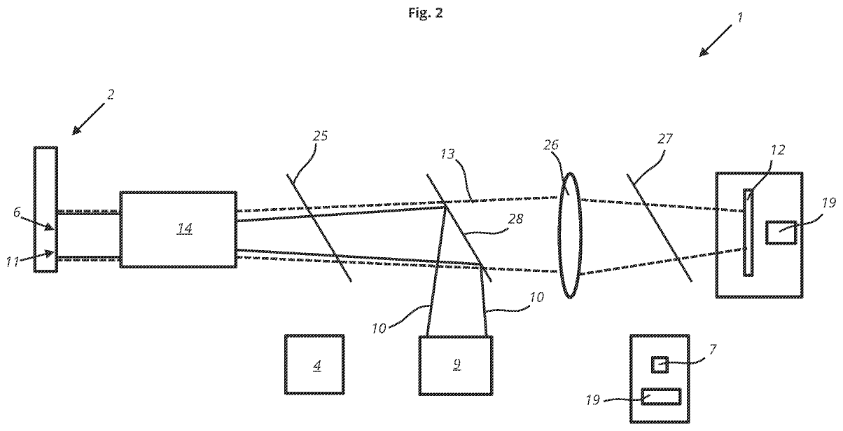

FIG. 2 shows part of the device of the first embodiment, in which a second light source is switched on,

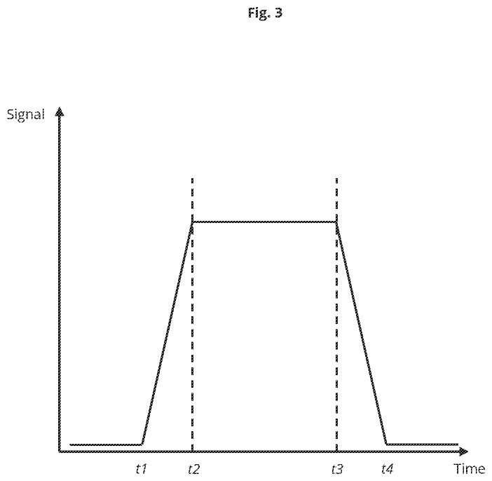

FIG. 3 shows a signal curve detected by the point detector,

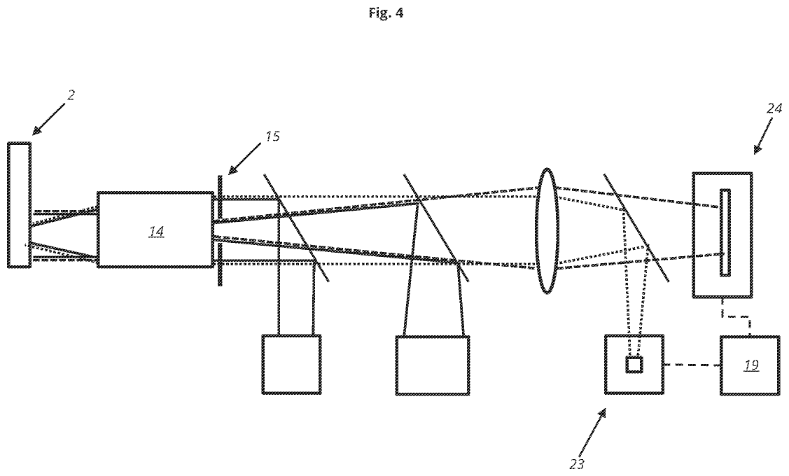

FIG. 4 shows a device according to a second embodiment, in which the first light source and the second light source are switched on,

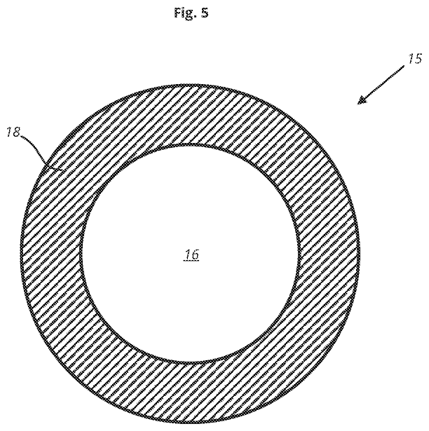

FIG. 5 shows a front view of a filter element,

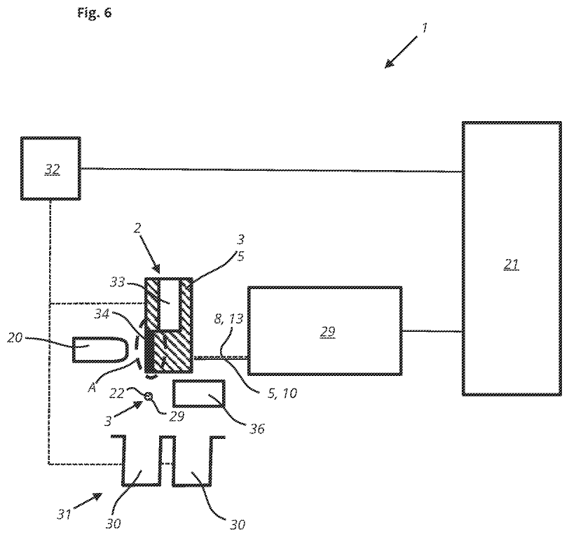

FIG. 6 shows a detailed construction of the device according to the invention,

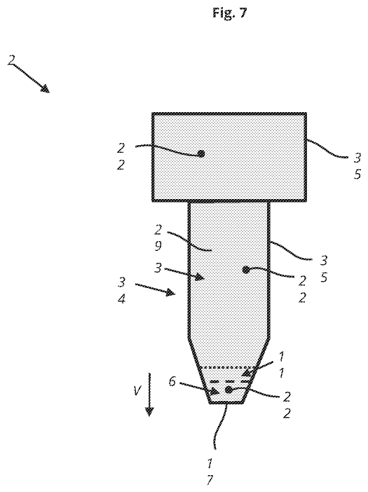

FIG. 7 shows an enlarged representation of a part of a dispenser of the device according to the invention,

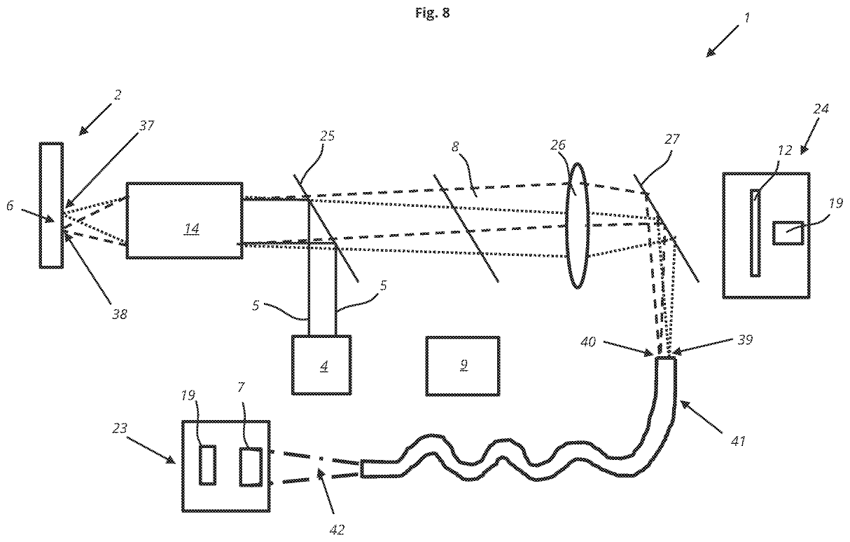

FIG. 8 shows part of the device according to an embodiment in which the signal from the first region is guided into a light guide,

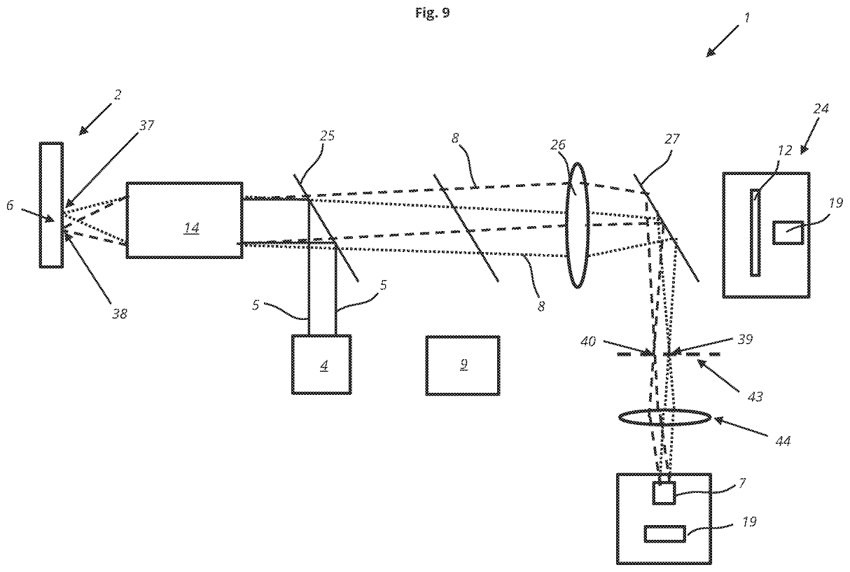

FIG. 9 shows part of the device according to an embodiment in which the signal from the first region is directed to the point detector via a further lens.

A device 1 shown in FIG. 1 has a dispenser 2 which is used to receive liquid sample 3. Only a part of the dispenser 2 is shown in FIG. 1. As can be seen from FIG. 6, the liquid sample 3 has a liquid 29 and particles 22. The device 1 also has a first light source 4 of a first type for emitting a first illumination light 5 for illuminating a first region 6 of the dispenser 3. In addition, the device 1 has a first detection device 7 for detecting a first optical measurement signal 8 which emanates from the first region 6 of the dispenser 3 illuminated with the first illumination light 5. The first detection device 7 is designed as a point detector.

In the embodiment shown in FIG. 1, the first light source 4 is switched on, so that the first light source 4 emits the first illumination light 5. The first illumination light 5 is shown as a solid line and the first optical measurement signal 8 is shown as a dashed line.

The device 1 also has a second light source 9 of a second type for emitting a second illumination light 10 shown in FIG. 2 for illuminating a second region 11 of dispenser 2 comprising the first region 6 of dispenser 3. A second detection device 12 serves to detect a second optical measurement signal 13 shown in FIG. 2, which emanates from the second region 11 of dispenser 2 illuminated by second illumination light 10. In the embodiment shown in FIG. 1, the second light source 9 is switched off. Therefore, no beam path represented by the first light source 9 is shown in FIG. 1.

The first light source 4 can be a fluorescence light source, by means of which excitation light is provided as the first illumination light 5. The second light source 9 can be an incident light source, by means of which bright field light is provided as the second illumination light 10.

The point detector is part of a first detection system 23. The first detection system 23 has an evaluation device 19 for evaluating the first optical measurement signal 8 detected in the point detector. The second detection device 12 can be an area sensor and/or part of a second detection system 24.

The device 1 has an objective 14 and a first deflection device 25. The deflection device 25 serves to deflect the first illumination light 5 emanating from the first light source 4 in the direction of the objective 14. The first illumination light 5 entering the objective 14 is used to illuminate the first region 6 of the dispenser 2.

The first optical measurement signal 8 emanating from the first region 6 as a result of the illumination passes through the objective 14. In addition, the first optical measurement signal 8 passes through the first deflection device 25 without being deflected. A converging lens 26 focuses the first optical measurement signal 8, the focused first optical measurement signal 8 being deflected onto the point detector 7 by a second deflection device 27. The point detector 7 thus receives the first optical measurement signal 8 emanating from the first region 6.

In the embodiment shown in FIG. 1, the converging lens 26 is arranged in front of the second deflection device 27. Alternatively, the converging lens 26 can be arranged behind the second deflection device 27. In this version, an additional converging lens is required, so that the version has two converging lenses, one converging lens for each beam path.

FIG. 2 shows part of the device 1 according to the first embodiment, in which the second light source 9 is switched on. The second illumination light 10 is shown as a solid line and the second optical measurement signal 13 is shown as a dashed line. In this embodiment, the first light source 4 is switched off.

The second illumination light 10 emitted by the second light source 9 is deflected towards the objective 14 by a third deflection device 28. The second illumination light 10 passes through the objective 14 and illuminates the second region 11. The second region 11 comprises the first region 6. The second optical measurement signal 13 emanating from the second region 11 as a result of the illumination is imaged onto the second detection device 12 by the objective 14 and the converging lens 26. In this case, the second optical measurement signal 13 passes between the converging lens 26 and the objective 14, the first deflection device 25 and the third deflection device 28, where it is not deflected or only partially deflected by them.

FIG. 3 shows a signal curve detected by the point detector. From a first point in time t1, the point detector receives a signal. A particle 22 enters the first region 6 at the first point in time t1. In other words, a dispensing process has taken place before the first point in time t1 and liquid sample 3, which has the particle 22, enters the first region 6. From a second point in time t2, the particle 22 is stationary in the first region 6. This means that the refilling process of the first region 6 with liquid sample 3 is completed at the second point in time t2.

From the third point in time t3, the particle 22 moves. This results because a dispensing operation is performed in which the liquid sample 3 is ejected from the first region 6. The particle 22 is ejected from the dispenser 2 at a fourth point in time t4.

The evaluation device 19 can use the first optical measurement signal 8 detected by the point detector to determine whether or not there is a particle in the first region 6. In the signal curve shown in FIG. 3, the evaluation device 19 will determine that a particle is located in the first region 6 because a maximum signal value is greater than a stored signal value that is not shown. Alternatively or additionally, the evaluation device will determine a signal integral between the first to fourth points in time t1 to t4. Since the integral value is greater than a stored value that is not shown, the evaluation device 19 determines that a particle is arranged in the first region 6.

As already explained above, the control device 21 causes the first light source 4 to be switched on at the latest at the first point in time t1 and/or not to be switched off before the fourth point in time t4. Optionally, the first light source 4 remains on permanently and the control device 21 causes only the detected first measurement signal of the first detection device 7 to be recorded or evaluated between time t1 and time t4. In addition, the control device 21 causes the second light source 9 to be switched on at the earliest at the second point in time t2 and switched off at the latest at the third point in time t3. This means that the second light source 9 is only switched on when the particle is not moving. Optionally, the second light source 9 can also be switched on permanently, for which the control unit 21 causes the second detection device 12 to receive the second measurement signal at the earliest from point in time t2 and the detection is ended at the latest at point in time t3. In this case, the exposure time starts at the earliest at the second point in time t2 and ends at the latest at the third point in time t3. The second point in time t2 can be offset by a predetermined first period of time from an actuation point in time, not shown, at which the actuation means 20 is actuated. The third point in time t3 can be offset by a predetermined second time period from the second point in time t2. Depending on the dispensing process and the type of lighting, the signal curve can also look different.

FIG. 4 shows a device 1 according to a second embodiment, in which the first light source 4 and the second light source 9 are switched on. The device 1 shown in FIG. 4 differs from the device 1 shown in FIGS. 1 and 2 in that there is an evaluation device 19 which is electrically connected to the first detection system 23 and to the second detection system 24. The evaluation device 19 evaluates the optical measurement signals 8, 13 detected by the first detection device 7 and by the second detection device 12.

Another difference is that the device has a filter element 15. The filter element 15 is connected downstream of the objective 14 as viewed in relation to the beam path of the first and second optical measurement signals 8, 13.

FIG. 5 shows a front view of the filter element 15. The filter element 15 has a first filter region 16 and a second filter region 18. The second filter region 18 encloses the first filter region 16. Both filter regions are arranged to be coaxial to one another. The first filter region 16 can be an opening in the filter element 15.

As can be seen from FIG. 4, both the first optical measurement signal 8 and the second optical measurement signal 13 pass through the first filter region 16. In contrast, the second filter region 18 is designed in such a way that it filters the second optical measurement signal 13. Thus, only the first optical measurement signal 8 penetrates through the second filter region 18.

FIG. 6 shows a detailed structure of the device 1 according to the invention. The device 1 shown in FIG. 6 can have the structure shown in FIG. 1, 2, or 4. For reasons of simplification, FIG. 6 shows an element 29 which, with the exception of the dispenser 2, contains all the components shown in FIGS. 1-6.

A state is shown in FIG. 6 in which a liquid sample 3 has been dispensed through the dispenser 2. The dispensed liquid sample 3 comprises a liquid 29 and at least one particle 22. In addition, the device 1 has an actuating means 20 which is used to actuate the dispenser 2. The liquid sample 3 is dispensed through the dispenser 2 by the actuator 20 actuating the dispenser 2. The liquid sample 3 is fed into a receptacle 30 of a carrier 31.

The device 1 has a control device 21 which is electrically connected to one or more evaluation devices 19. The evaluation devices 19 are shown in FIGS. 1, 2, and 4. FIG. 6 also shows the first and second illumination lights 5, 10 and the first and second optical measurement signals 8, 13.

The dispensing device 1 also has a moving device 32, by means of which the dispenser 2 and/or the carrier 31 are moved, as illustrated by the dashed line. A control device 32 is electrically connected to the moving device 21. The control device 21 controls the movement process of the dispenser 2 and/or the carrier 31 by means of the movement device 32. This is necessary in order to determine the storage location of the liquid sample 3 to be dispensed. As described above, control is performed based on the evaluation result.

The dispenser 2 has a fluid chamber 33. The liquid sample 3 is introduced into the fluid chamber 33 through an opening of the fluid chamber 33. In addition, the dispenser 2 has an output channel 34. The output channel 34 is fluidically connected to the fluid chamber 33. The liquid sample 3 is discharged from the dispenser 2 through the output channel 34. The output channel 34 and the fluid chamber 33 are delimited by a transparent wall 35 of the dispenser 2. The actuating means 20 and an objective 14, not shown in FIG. 6, are opposite one another with respect to the dispenser 2.

The device also has a deflection and/or suction device 36. By means of the deflection and/or suction device 36, a dispensed liquid sample 3 can be deflected into a desired receptacle 30 and/or suctioned out before it reaches a receptacle 30. The deflection and/or suction device 36 is electrically connected to the control device 21 and is controlled by the control device 21.

FIG. 7 shows an enlarged representation of part of a dispenser 2 of the device 3 which is filled with liquid sample 3. The liquid 29 of the liquid sample 3 contained in the part has a gray background. FIG. 7 shows the region A of the dispenser 2 that is dashed in FIG. 6. The first region 6 illuminated by the first illumination light 5 comprises a dispensing outlet 17. The dispensing outlet 17 is an outlet opening of the output channel 34 through which the liquid sample 3 is dispensed from the dispenser 2. The second region 11 illuminated by the second illumination light 10 comprises the first region 6. The first region 6 corresponds to a dispensing region that contains the liquid sample 3 that is ejected in the next dispensing process. A single particle 22 is contained in the first region 6, so that a droplet containing the particle 22 is ejected during the next dispensing process. The liquid sample 3 is ejected along an ejection direction V.

The second region 11 is larger than the first region 6. The second region 11 thus also comprises a region of the output channel 34 that contains liquid sample 3 that is not ejected during the next dispensing process.

FIG. 8 shows a representation of part of the device in which the light from the first region 6 is directed onto the input of a light guide 41. It is illustrated here by way of example that light from a particle located at a point 37 in the liquid sample is imaged at a point 39 on the entrance of the light guide and light from a particle that is located at a different point 38 is imaged at another location 40 on the input of the light guide. By using a suitable light guide 41 with a sufficient length and possibly bending the light guide, “mode scrambling” is generated, as a result of which the light always emerges at the output of the light guide in a specific light cone 42 that depends on the light guide. This is the case regardless of the entry point of the light guide. The light cone can then impinge on the first detection device 7 directly or through a further optical system (not shown).

FIG. 9 shows a representation of part of the device in which the light from the first region 6 is imaged in the image plane 43. In contrast to FIG. 1, however, the first detection device is not located here, but this image plane is located in the back focal plane of a lens 44. As a result, the light emanating from each point of the plane 43 is collimated again. Thus, each point in the first region 6 behind the lens 44 produces a collimated light beam. If the light-generating point, such as a particle or part thereof, in the first region 6 is not exactly in the focal plane, then the light beam behind the lens 44 will be slightly convergent or divergent. The first detection device 7 is now located behind the lens 44, advantageously exactly at the distance of the focal length of the lens. This is illuminated over a large region in this arrangement. Depending on the position of the particle, the resulting light beam strikes the detector at an angle, as is indicated in the examples with the dotted and dashed light paths. However, this angle and a slightly convergent or divergent beam are irrelevant as long as the majority of the detector surface is illuminated. Because of the planar illumination of the first detection device 7, the arrangement has the advantages mentioned in comparison to the arrangement in FIG. 1.

### LIST OF REFERENCE SYMBOLS

1 Device
2 Dispenser
3 Liquid sample
4 First light source
First illuminating light
6 First region of the dispenser
7 First detection device
8 First optical measurement signal
9 Second light source
10 Second illuminating light
11 Second region of the dispenser
12 Second detection device
13 Second optical measurement signal
14 Objective
15 Filter element
16 First filter region
17 Dispensing outlet
18 Second filter region
19 Evaluation device
20 Actuating means
21 Control device
22 Particle
23 First detection system
24 Second detection system
25 First deflection device
26 Converging lens
27 Second deflection device
28 Third deflection device
29 Liquid
30 Receptacle
31 Carrier
32 Moving device
33 Fluid chamber
34 Output channel
35 Wall
36 Deflection and/or suctioning device
37 Location of particles in liquid sample
38 Different location of particles in liquid sample
39 Point at the entrance to the light guide
40 Different location at the entrance in light guide
41 Light guide
42 Light cones
43 Image plane
44 Lens
V Ejection direction

1.-25. (canceled)

26. A device comprising:
a dispenser for receiving liquid sample, which has liquid and particles;
a first light source of a first type for emitting a first illumination light for illuminating a first region of the dispenser;
a first detection device for detecting a first optical measurement signal which emanates from the first region of the dispenser illuminated with the first illuminating light;
a second light source of a second type for emitting a second illumination light for illuminating a second region of the dispenser which comprises the first region of the dispenser; and
a second detection device for detecting a second optical measurement signal which emanates from the second region of the dispenser illuminated with the second illuminating light; wherein
the first detection device is a point detector.

27. The device according to claim 26, wherein:
a. the first region comprises a dispensing outlet; and/or
b. the second region completely comprises the first region; and/or
c. the second region is larger than the first region; and/or
d. the first region (6) comprises a dispensing region from which the liquid sample is dispensed from the dispenser during a dispensing process.

28. The device according to claim 26, wherein:
a. the second region comprises a dispensing outlet; and/or
b. the second region comprises at least the dispensing region from which the liquid sample is dispensed from the dispenser during a dispensing process; and/or
c. the device has an objective that is arranged in such a way that its optical axis is transverse or perpendicular to an ejection direction of liquid sample from the dispenser; and/or
d. the device has an objective that has a numerical aperture of 0.1 to 1.5.

29. The device according to claim 26, wherein the device has a filter element for filtering a part of the measurement signal.

30. The device according to claim 29, wherein
a. the filter element has a first filter region through which the first and second measurement signals penetrate; or
b. the filter element has a first filter region through which the first and second measurement signals penetrate, the first filter region being a perforation.

31. The device according to claim 29, wherein the filter element has a second filter region which:
a. the second measurement signal filters; and/or
b. is designed such that the first measurement signal penetrates through the second filter region; and/or
c. encloses the first filter region.

32. The device according to claim 29, wherein the filter element is arranged in a beam path of the first and/or second measurement signals after an objective and before the point detector and/or the second detection device.

33. The device according to claim 26, wherein:
a. the first illumination light is excitation light and/or the first measurement signal is a fluorescence signal; and/or
b. the second illumination light is bright field light and/or the second measurement signal is a bright field signal.

34. The device according to claim 26, wherein the device has at least one evaluation device for evaluating the first measurement signal and/or the second measurement signal.

35. The device according to claim 34, wherein:
a. the evaluation device determines based on the first measurement signal whether at least one particle is arranged in the first region; and/or
b. the evaluation device determines that at least one particle is arranged in the first region when the detected first measurement signal satisfies a predetermined condition; and/or
c. the evaluation device based on the second measurement signal determines whether in the second region a predetermined number of particles are arranged; and/or
d. the evaluation device determines a physical particle property based on the second measurement signal.

36. The device according to claim 26, wherein the device comprises an actuator configured to actuate the dispenser for dispensing liquid sample.

37. The device according to claim 26, wherein the device has a control device.

38. The device according to claim 37, wherein:
a. the control device causes the first light source to be switched on before the second light source; and/or
b. the control device causes an exposure time by the first illumination light to be longer than an exposure time by the second illumination light; and/or
c. the control device causes the first light source to be switched on during a dispensing process; and/or
d. the control device causes the first light source to be switched on, regardless of whether the particle is moving in the first region; and/or
e. the control device determines a storage location depending on an evaluation result; or
f. the control device determines a storage location depending on the evaluation result and causes the dispenser to dispense liquid sample into the specific storage location.

39. The device according to claim 26, wherein:
a. the first illumination light and the first measurement signal at least partially have a common beam path; and/or
b. the second illuminating light and the second measurement signal at least partially have a common beam path; and/or
c. the first and the second illuminating lights at least partially have a common beam path; and/or
d. the first measurement signal and the second measurement signal at least partially have a common beam path.

40. The device according to claim 26, wherein the device has a light guide.

41. The device according to claim 40, wherein:
a. the light guide is arranged in a beam path of the first optical measurement signal; and/or
b. the first optical measurement signal emerging from the light guide is fed to the first detection device; and/or
c. the first region is imaged at an entrance of the light guide; and/or
d. the light guide is designed in such a way that the first optical measurement signal exiting the light guide has a more uniform intensity distribution profile than the first optical measurement signal entering the light guide.

42. The device according to claim 40, wherein the light guide is a glass fiber and/or a liquid-filled light guide.

43. The device according to claim 26, wherein the device has a lens which is arranged in a beam path of the first optical measurement signal.

44. The device according to claim 43, wherein:
a. the lens collimates the first optical measurement signal or the lens collimates the first optical measurement signal and the lens and the first detection device are arranged in such a way that the first detection device is supplied with the collimated first optical measurement signal; and/or
b. the first detection device is arranged in such a way that a distance between the first detection device and the lens corresponds to a distance of the focal length of the lens.

45. A method for examining a liquid sample, comprising:
providing a device comprising:
a dispenser for receiving liquid sample, which has liquid (29) and particles;
a first light source of a first type for emitting a first illumination light for illuminating a first region of the dispenser;
a first detection device for detecting a first optical measurement signal which emanates from the first region of the dispenser illuminated with the first illuminating light;
a second light source of a second type for emitting a second illumination light for illuminating a second region of the dispenser which comprises the first region of the dispenser; and
a second detection device for detecting a second optical measurement signal which emanates from the second region of the dispenser illuminated with the second illuminating light;
wherein the first detection device is a point detector; and
using the device to examine a liquid sample.
